(19) United States
(12) Patent Application Publication
(10) Pub. No.: US 2022/0066237 A1
(43) Pub. Date: Mar. 3, 2022

(54) PLASTIC LENS AND EYE GLASSES

(71) Applicant: TOKAI OPTICAL CO., LTD., Okazaki-Shi (JP)

(72) Inventor: Hiroshi UENO, Okazaki-Shi (JP)

(73) Assignee: TOKAI OPTICAL CO., LTD., Okazaki-Shi (JP)

(21) Appl. No.: 17/310,538

(22) PCT Filed: Feb. 20, 2020
(86) PCT No.: PCT/JP2020/006879

§ 371 Date: Aug. 10, 2021

(30) Foreign Application Priority Data
Mar. 4, 2019 (JP) 2019-038720

(51) Int. Cl. G02C 7/02; G02C 7/10; G02B 1/04; G02B 3/00; C08G 18/76

(52) U.S. Cl. CPC G02C 7/022; G02C 7/10; C08G 18/76; G02B 3/00; G02B 1/041

(57) ABSTRACT

[Object]

Provided are a plastic lens and spectacles having a high HEV cut rate represented as 100−(average transmittance in a wavelength range of not less than 400 nm and not greater than 420 nm).

[Solution]

A plastic lens according to the present invention includes a plastic lens base material obtained as a result of curing of a polymerizable compound having mixed therein a benzotriazole compound represented by general formula (1) below. Spectacles according to the present invention is produced by using the above-described plastic lens as a plastic spectacle lens.

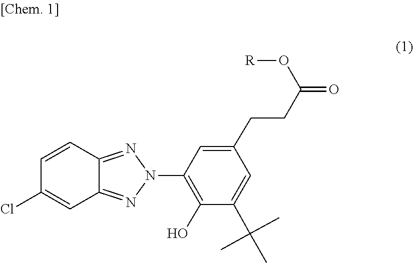

### TECHNICAL FIELD

The present invention relates to a plastic lens that reduces (cuts) transmission of ultraviolet rays and light (blue light) on the short wavelength side of a visible range, and eye glasses (spectacles) using the plastic lens.

### BACKGROUND ART

As a plastic lens to which 2-(4-butoxy-2-hydroxyphenyl)-2H-benzotriazole is added as an ultraviolet absorber, a plastic lens described in Japanese Laid-Open Patent Publication No. 2015-34990 (paragraph [0112]) is known.

In this plastic lens, ultraviolet rays in a wavelength range of less than 400 nm (nanometer) are cut.

### SUMMARY OF THE INVENTION

### Problems to be Solved by the Invention

Recently, from the viewpoint of health of eyes, light that is on the short wavelength side of a visible range, that has high energy in the visible range, and that has a wavelength of not less than 400 nm and not greater than 420 nm (so-called HEV: High Energy Violet light), has been tried to be cut.

However, the plastic lens containing the ultraviolet absorber described above has a limit in improvement of an HEV cut rate, which is the percentage of cutting HEV, i.e., 100-(average transmittance in a wavelength range of not less than 400 nm and not greater than 420 nm) [%].

A main object of the present invention is to provide a plastic lens having a higher HEV cut rate and spectacles.

### Solution to the Problems

In order to attain the above object, a first aspect of the invention is a plastic lens including a plastic lens base material obtained as a result of curing of a polymerizable compound having mixed therein a benzotriazole compound represented by general formula (1) described later (in general formula (1), R represents an alkyl group having not less than 1 and not more than 8 carbon atoms).

In a second aspect of the invention based on the above invention, the polymerizable compound may contain a combination of a xylene diisocyanate and a polythiol.

In a third aspect of the invention based on the above invention, the xylene diisocyanate may be m-xylene diisocyanate.

In a fourth aspect of the invention based on the above invention, the polythiol may be at least one of bis(mercaptomethyl)-3,6,9-trithio-1,11-undecanedithiol and 1,2-bis(2-mercaptoethylthio)-3-mercaptopropane.

In a fifth aspect of the invention based on the above invention, an HEV cut rate represented as 100-(average transmittance in a wavelength range of not less than 400 nm and not greater than 420 nm) may be not less than 94%.

In a sixth aspect of the invention based on the above invention, the benzotriazole compound may be a benzotriazole compound in which R in general formula (1) described later is represented by an alkyl group having 1 carbon atom, and may be at a proportion of less than 1.50 parts by weight relative to 100 parts by weight of the polymerizable compound.

In a seventh aspect of the invention based on the above above-described invention, the benzotriazole compound may be a benzotriazole compound in which R in the general formula (1) is represented by an alkyl group having 8 carbon atoms, and may be at a proportion of less than 0.62 parts by weight relative to 100 parts by weight of the polymerizable compound.

In order to attain the above object, an eighth aspect of the invention is spectacles in which the plastic lens according to the above invention may be used.

### Advantageous Effects of the Invention

A main effect of the present invention is that a plastic lens and spectacles having a higher HEV cut rate are provided.

### BRIEF DESCRIPTION OF THE DRAWINGS

FIG. 1 is a graph showing a spectral transmittance distribution in a wavelength range of not less than 390 nm and not greater than 450 nm in each of Examples 1 to 4 and Comparative Example 1.

FIG. 2 is a graph showing a spectral transmittance distribution in a wavelength range of not less than 390 nm and not greater than 450 nm in Example 6 and Comparative Example 1.

FIG. 3 is a graph showing a spectral transmittance distribution in a wavelength range of not less than 390 nm and not greater than 450 nm in Examples 8 and 9 and Comparative Example 2.

### DESCRIPTION OF EMBODIMENTS

Hereinafter, an example of an embodiment according to the present invention will be described.

The present invention is not limited to the embodiment below.

In a plastic lens according to the present invention, a xylene diisocyanate and a polythiol are used as a polymerizable compound (resin monomer) for forming a plastic lens base material.

The plastic lens base material contains a thiourethane obtained through polymerization and curing of the xylene diisocyanate and the polythiol.

The xylene diisocyanate is o-xylene diisocyanate, m-xylene diisocyanate, or p-xylene diisocyanate, or a composition that contains at least any two of these.

The polythiol is, for example, bis(mercaptomethyl)-3,6,9-trithio-1,11-undecanedithiol, and more specifically, for example, 4,8-bis(mercaptomethyl)-3,6,9-trithio-1,11-undecanedithiol, 4,7-bis(mercaptomethyl)-3,6,9-trithio-1,11-undecanedithiol, or 5,7-bis(mercaptomethyl)-3,6,9-trithio-1,11-undecanedithiol, or a composition that contains at least any two of these.

Alternatively, the polythiol is 1,2-bis(2-mercaptoethylthio)-3-mercaptopropane. It should be noted that the polythiol may be a mixture of bis(mercaptomethyl)-3,6,9-trithio-1,11-undecanedithiol and 1,2-bis(2-mercaptoethylthio)-3-mercaptopropane.

Since the plastic lens base material contains the thiourethane described above, the plastic lens base material has a high refractive index of about 1.67.

Further, the polymerizable compound forming the plastic lens base material has added thereto a benzotriazole compound represented by general formula (1) below, and the benzotriazole compound represented by general formula (1) below is mixed, as an ultraviolet absorber, to the plastic lens base material.

In general formula (1), R represents an alkyl group having not less than 1 and not more than 8 carbon atoms.

The ultraviolet absorber has introduced therein a substituent containing a propionate ester and a chlorine substituent.

In particular, when the number of carbon atoms in R is 1, the ultraviolet absorber is a benzotriazole compound represented by formula (1-1) below, i.e., methyl=3-[3-t-butyl-5-(5-chloro-2H-benzotriazol-2-yl)-4-hydroxyphenyl]propionate.

When the number of carbon atoms in R is 8, the ultraviolet absorber is a benzotriazole compound represented by formula (1-2) below, i.e., octyl=3-[3-t-butyl-5-(5-chloro-2H-benzotriazol-2-yl)-4-hydroxyphenyl]propionate.

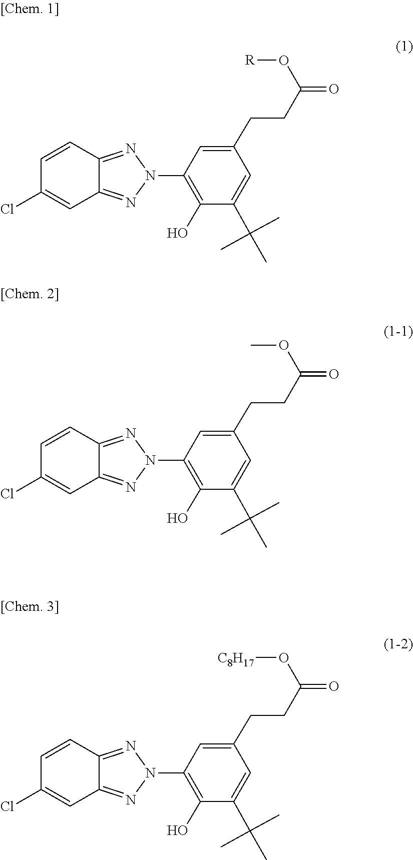

Such an ultraviolet absorber is mixed, before the plastic lens base material is cured, to a polymerizable composition containing the resin monomers described above and becomes a part of the plastic lens base material due to curing of the polymerizable composition.

In the plastic lens base material, in order to increase the HEV cut rate described above, the addition amount of the ultraviolet absorber needs to be increased. Meanwhile, with respect to the polymerizable composition containing the resin monomers described above, the amount (concentration) at the time of precipitation in the polymerizable composition of the ultraviolet absorber, which is a benzotriazole compound represented by general formula (1), is high. Consequently, the benzotriazole compound does not precipitate even when a large amount, compared with another type of ultraviolet absorber, is added. Therefore, the HEV cut rate of the plastic lens base material is sufficiently increased, by the addition of the ultraviolet absorber, which is the benzotriazole compound represented by general formula (1).

The thickness of the plastic lens base material is not limited in particular. However, when the thickness is increased, the internal transmittance is proportionally decreased, and the appearance and weight as a plastic lens (in particular, a plastic spectacle lens) is comparatively worsened. Therefore, the thickness of the plastic lens base material is preferably not greater than 4 mm (millimeter).

One or more of various types of films may be formed on one side or both sides of the plastic lens base material. For example, at least one of an optical multilayer film such as an antireflection film and a hard coating film may be formed, or a primer film may be formed between a hard coating film and the plastic lens base material. As a film on the most front surface side, an antifouling film (water repellent film/oil repellent film) may be formed. Whether or not a film is added, or which type of a film is added, may be varied between the sides of the plastic lens base material.

Spectacles having a sufficiently high HEV cut rate are produced by using the above plastic lens as a plastic spectacle lens.

### EXAMPLES

Next, Examples 1 to 9 of the present invention and Comparative Examples 1, 2 not belonging to the present invention are described with reference to the drawings as appropriate. It should be noted that the present invention is not limited to the Examples below. Furthermore, according to the interpretation of the present invention, Examples may be regarded as Comparative Examples, and Comparative Examples may be regarded as Examples.

### Production of Example 1

As Example 1, 0.15 parts by weight of methyl=3-[3-t-butyl-5-(5-chloro-2H-benzotriazol-2-yl)-4-hydroxyphenyl]propionate (see formula (1-1) above, Eversorb88 manufactured by EverLight Chemical Industrial Corporation, hereinafter, this may be referred to as “u1”), 0.007 parts by weight of dibutyltin dichloride, and 0.085 parts by weight of an internal mold release agent were blended with a total of 100 parts by weight composed of 50.4 parts by weight of m-xylene diisocyanate (see formula (2) below, MR-10A manufactured by Mitsui Chemicals, Inc., hereinafter, this may be referred to as “al”), and 49.6 parts by weight of a polythiol composition (MR-10B manufactured by Mitsui Chemicals, Inc., hereinafter, this may be referred to as “b1”) of which the main components were 4,8-bis(mercaptomethyl)-3,6,9-trithio-1,11-undecanedithiol (see formula (3-1) below), 4,7-bis(mercaptomethyl)-3,6,9-trithio-1,11-undecanedithiol (see formula (3-2) below), and 5,7-bis(mercaptomethyl)-3,6,9-trithio-1,11-undecanedithiol (see formula (3-3) below). The resultant mixture was stirred to be dissolved. This liquid preparation was subjected to degassing and stirring under 10 mmHg for 60 minutes, and then, was poured into a plano lens glass mold having a center thickness of 2 mm. The glass mold was subjected to curing for 18 hours while the temperature was increased from 15° C. to 140° C., and then, was cooled to room temperature, whereby a plano lens having a thickness of 2 mm was produced.

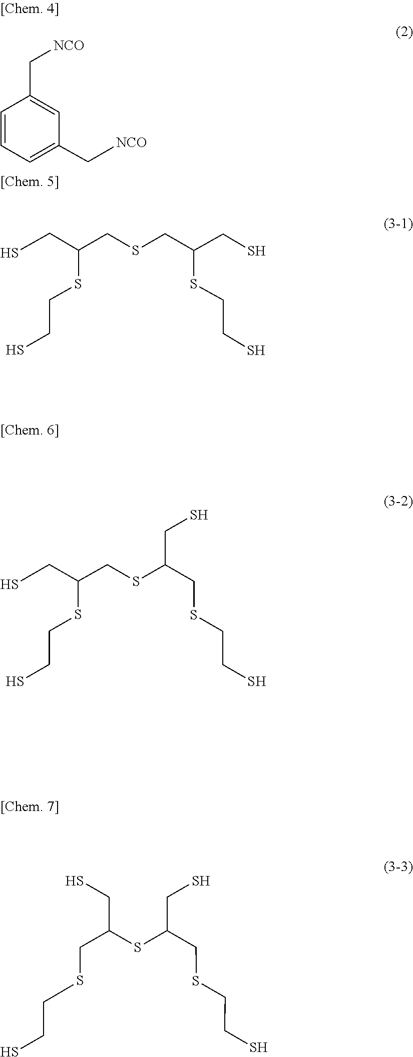

### Production of Examples 2 to 5

As Example 2, a plano lens having a thickness of 2 mm was produced by the same method as that in Example 1, except that the amount of u1 in Example 1 was changed to 0.50 parts by weight (0.50% by weight relative to the total weight of the polymerizable composition part).

As Example 3, a plano lens having a thickness of 2 mm was produced by the same method as that in Example 1, except that the amount of u1 in Example 1 was changed to 1.10 parts by weight (1.10% by weight relative to the total weight of the polymerizable composition part).

As Example 4, a plano lens having a thickness of 2 mm was produced by the same method as that in Example 1, except that the amount of u1 in Example 1 was changed to 1.30 parts by weight (1.30% by weight relative to the total weight of the polymerizable composition part).

As Example 5, a plano lens having a thickness of 2 mm was produced by the same method as that in Example 1, except that the amount of u1 in Example 1 was changed to 1.50 parts by weight (1.50% by weight relative to the total weight of the polymerizable composition part).

<<Production of Examples 6 and 7>>

As Example 6, a plano lens having a thickness of 2 mm was produced by the same method as that in Example 1, except that u1 in Example 1 was changed to 0.50 parts by weight (0.50% by weight relative to the total weight of the polymerizable composition part) of octyl=3-[3-t-butyl-5-(5-chloro-2H-benzotriazol-2-yl)-4-hydroxyphenyl]propionate (see formula (1-2) above, Eversorb109 manufactured by EverLight Chemical Industrial Corporation, hereinafter, this may be referred to as “u2”).

As Example 7, a plano lens having a thickness of 2 mm was produced by the same method as that in Example 1, except that 0.62 parts by weight (0.62% by weight relative to the total weight of the polymerizable composition part) of u2 was used instead of u1 in Example 1.

<<Production of Comparative Example 1>>

As Comparative Example 1, a plano lens having a thickness of 2 mm was produced by the same method as that in Example 1, except that u1 in Example 1 was changed to 0.60 parts by weight (0.60% by weight relative to the total weight of the polymerizable composition part) of 2-(4-butoxy-2-hydroxyphenyl)-2H-benzotriazole (see formula (4) below and BACKGROUND ART, Dainsorb T-53 manufactured by Daiwa Fine Chemicals Co., Ltd., hereinafter, this may be referred to as “u3”).

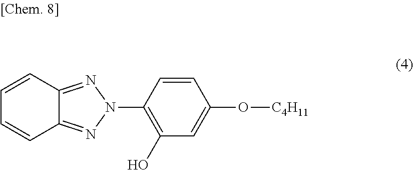

### Characteristics and the Like of Examples 1 to 7 and Comparative Example 1

Characteristics (here, HEV cut rate, YI value, appearance) of a resin composition and a resin cured product (piano lens) of each of Examples 1 to 7 and Comparative Example 1 are shown in [Table 1] below.

TABLE 1

| | Resin composition | | | | | | |
|---|---|---|---|---|---|---|---|
| | | | | Addition amount of | | | |
| | | Resin | | ultraviolet absorber | | | |
| | | monomer | | relative to 100 parts | | | |
| | | ratio | | by weight of resin | Resin cured product | | |
| | Resin | (weight | Ultraviolet | monomer | HEV cut | YI | Resin |
| | monomer | ratio) | absorber | (parts by weight) | rate (%) | value | appearance |
| Example 1 | a1, b1 | 50.4:49.6 | u1 | 0.15 | 61.54 | 3.2 | No abnormality |
| Example 2 | a1, b1 | 50.4:49.6 | u1 | 0.50 | 85.02 | 5.7 | No abnormality |
| Example 3 | a1, b1 | 50.4:49.6 | u1 | 1.10 | 94.73 | 8.7 | No abnormality |
| Example 4 | a1, b1 | 50.4:49.6 | u1 | 1.30 | 96.02 | 9.4 | No abnormality |
| Example 5 | a1, b1 | 50.4:49.6 | u1 | 1.50 | — | — | Precipitation of |
| | | | | | | | ultraviolet absorber |
| | | | | | | | observed |
| Example 6 | a1, b1 | 50.4:49.6 | u2 | 0.50 | 80.92 | 5.2 | No abnormality |
| Example 7 | a1, b1 | 50.4:49.6 | u2 | 0.62 | — | — | Precipitation of |
| | | | | | | | ultraviolet absorber |
| | | | | | | | observed |
| Comparative | a1, b1 | 50.4:49.6 | u3 | 0.60 | 43.29 | 2.2 | No abnormality |
| Example 1 | | | | | | | |

HEV cut rate (%):
100-(average of transmittance from 420 nm to 400)
a1: m-xylene diisocyanate
b1: polythiol composition having 4,8-bis(mercaptomethyl)-3,6,9-trithio-1,11-undecanedithiol, 4,7-bis(mercaptomethyl)-3,6,9-trithio-1,11-undecanedithiol, and 5,7-bis(mercaptomethyl)-3,6,9-trithio-1,11-undecanedithiol as main components
u1: methyl = 3-[3-t-butyl-5-(5-chloro-2H-benzotriazol-2-yl)-4-hydroxyphenyl]propionate
u2: octyl = 3-[3-t-butyl-5-(5-chloro-2H-benzotriazol-2-yl)-4-hydroxyphenyl]propionate
u3: 2-(4-butoxy-2-hydroxyphenyl)-2H-benzotriazole

First, with respect to the appearance of the plano lens, in Example 5 in which 1.50% by weight of the ultraviolet absorber u1 was added, a very small amount of precipitation of u1 was observed. Therefore, it is preferable that, with respect to 100 parts by weight of compositions of the lens base material other than u1 of Examples 1 to 5, u1 is added by less than 1.50 parts by weight.

In Example 7 in which 0.62% by weight of the ultraviolet absorber u2 was added, a very small amount of precipitation of u2 was observed. Therefore, it is preferable that, with respect to 100 parts by weight of compositions of the lens base material other than u2 in Examples 6 and 7, u2 is added by less than 0.62 parts by weight.

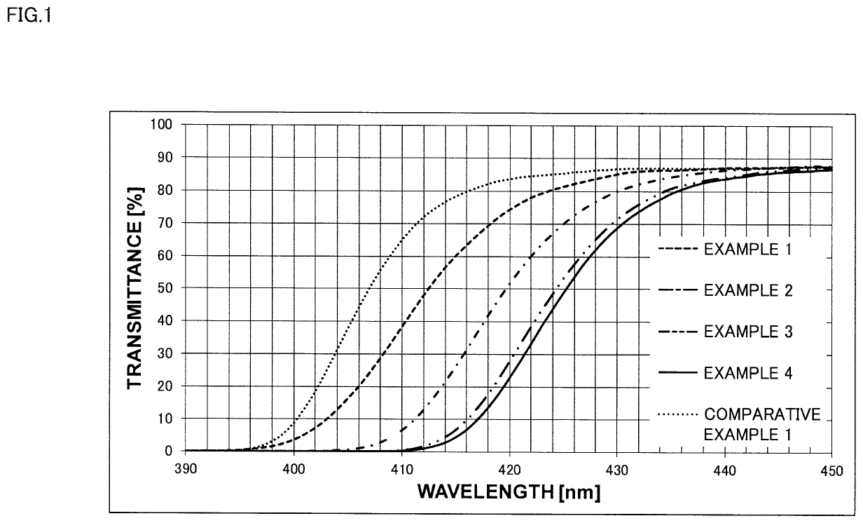

Next, with respect to the HEV cut rate, i.e., 100-(average transmittance in a wavelength range of not less than 400 nm and not greater than 420 nm) [%], in a case where the ultraviolet absorber is u1, as shown in FIG. 1, when compared with Comparative Example 1 in which the ultraviolet absorber is u3, the rising point of the transmittance distribution curve is shifted to the long wavelength side (420 nm side), i.e., from 394 nm (Comparative Example 1) to about 396, 404, 410, and 410 nm (Examples 1 to 4, respectively). The point at which the transmittance becomes 80% is shifted to the long wavelength side, i.e., from 416 nm (Comparative Example 1) to about 422, 430, 434, and 436 nm (Examples 1 to 4, respectively). As shown in the HEV cut rate column in [Table 1], the HEY cut rate is significantly increased, i.e., 61.54 to 96.02% (Examples 1 to 4, the addition amount of u1 is 0.15 to 1.30 parts by weight), relative to 43.29% (Comparative Example 1, the addition amount of u3 is 0.60 parts by weight).

In particular, in Examples 3 and 4, the HEV cut rate is not less than 94%, which is very high, and thus, Examples 3 and 4 have excellent eye protection ability.

It should be noted that in each of Examples 1 to 4 and Comparative Example 1, the transmittance (about 88%) at a wavelength of 450 nm is maintained up to a wavelength of at least 800 nm.

The YI value is represented, according to the formula below, by using tri-stimulus values X, Y, Z of a test sample in the standard illuminant in the XYZ color system.

YI=100(1.2769X−1.059Z)/Y

When the YI value is negative, the tint becomes more bluish. When the YI value is positive, the tint becomes more yellowish, and the magnitude of the positive indicates the degree of yellowishness (yellowness). The XYZ color system is adopted as a standard color system by the CIE (International Commission on Illumination), and is a system based on red, green, and blue that are the three primary colors of light, or an additive mixture thereof. A colorimeter for obtaining the stimulus values X, Y, Z in the XYZ color system is publicly known, and multiplication, of spectral energy of light to be measured, by a color-matching function for each of the stimulus values X, Y, Z for each wavelength, is performed and the results of the multiplication over all the wavelengths in a visible region are accumulated, to obtain the stimulus values X, Y, Z.

The YI values of Examples 1 to 4 are 3.2 to 9.4 in order, whereas the YI value of Comparative Example 1 is 2.2.

It should be noted that the transmittance distribution, the HEV cut rate, and the YI value in Example 5 have not been measured but are similar to those in Example 4.

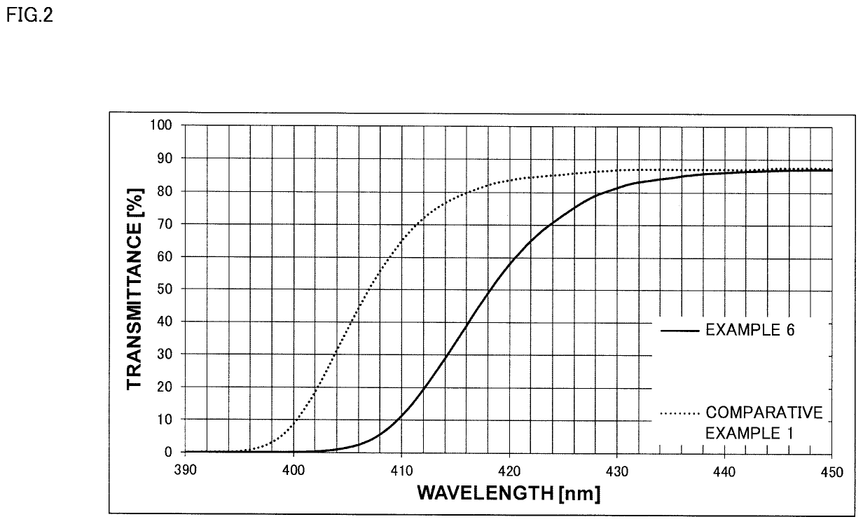

Meanwhile, in a case where the ultraviolet absorber is u2, as shown in FIG. 2, when compared with Comparative Example 1 in which the ultraviolet absorber is u3, the rising point of the transmittance distribution curve is shifted to the long wavelength side (420 nm side), i.e., from 394 nm (Comparative Example 1) to about 402 nm (Example 6). The point at which the transmittance becomes 80% is shifted to the long wavelength side, i.e., from 416 nm (Comparative Example 1) to about 429 nm (Example 6). As shown in the HEV cut rate column in [Table 1], the HEV cut rate is significantly increased, i.e., 80.92% (Example 6, the addition amount of u2 is 0.50 parts by weight), relative to 43.29% (Comparative Example 1, the addition amount of u3 is 0.60 parts by weight). In Example 6 as well, the transmittance (about 88%) at a wavelength of 450 nm is maintained up to a wavelength of at least 800 nm.

The YI value is 5.2 (Example 6), whereas the YI value in Comparative Example 1 is 2.2.

It should be noted that the transmittance distribution, the HEV cut rate, and the YI value in Example 7 have not been measured but are similar to those in Example 6.

### Summary and the Like of Examples 1 to 7 and Comparative Example 1

As shown in each of Examples 1 to 7 described above, when a plastic lens includes a plastic lens base material obtained as a result of curing of a polymerizable compound having mixed therein a benzotriazole compound represented by general formula (1) above, and the polymerizable compound contains a combination of a xylene diisocyanate (m-xylene diisocyanate) and a polythiol (bis(mercaptomethyl)-3,6,9-trithio-1,11-undecanedithiol), the plastic lens and spectacles using the plastic lens have a high HEV cut rate and excellent eye protection ability.

In particular, in Examples 3 and 4 described above, the HEV cut rate is not less than 94%, which is very high.

In addition, in Examples 1 to 4 described above, the ultraviolet absorber (formula (1-1) above) in which R in general formula (1) is represented by an alkyl group having 1 carbon atom is at a proportion of less than 1.50 parts by weight relative to 100 parts by weight of the polymerizable compound. Accordingly, precipitation of the ultraviolet absorber is prevented, and the appearances of the plastic lens and spectacles using the plastic lens become preferable.

Further, in Example 6 described above, the ultraviolet absorber (formula (1-2) above) in which R in general formula (1) is represented by an alkyl group having 8 carbon atoms is at a proportion of less than 0.62 parts by weight relative to 100 parts by weight of the polymerizable compound. Accordingly, precipitation of the ultraviolet absorber is prevented, and the appearances of the plastic lens and spectacles using the plastic lens become preferable.

### Production of Examples 8 and 9

As Example 8, 0.15 parts by weight of u1 in Example 1, 0.012 parts by weight of dibutyltin dichloride, and 0.085 parts by weight of the internal mold release agent were blended with a total of 100 parts by weight composed of 52.0 parts by weight of al in Example 1 and 48.0 parts by weight of 1,2-bis(2-mercaptoethylthio)-3-mercaptopropane (see formula (5) below, MR-7B manufactured by Mitsui Chemicals, Inc., hereinafter, this may be referred to as “b2”). The resultant mixture was stirred to be dissolved. This liquid preparation was subjected to degassing and stirring under 10 mmHg for 60 minutes, and then, was poured into a plano lens glass mold having a center thickness of 2 mm. The glass mold was subjected to curing for 19 hours while the temperature was increased from 20° C. to 140° C., and then, was cooled to room temperature, whereby a plano lens having a thickness of 2 mm was produced.

As Example 9, a plano lens having a thickness of 2 mm was produced by the same method as that in Example 8, except that the amount of u1 in Example 8 was changed to 1.10 parts by weight (1.10% by weight relative to the total weight of the polymerizable composition part).

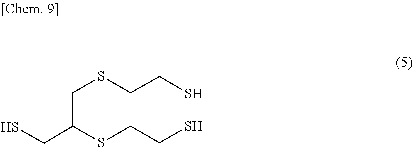 [SMILES: SCCSCC(CS)SCCS]

### Production of Comparative Example 2

As Comparative Example 2, a plano lens having a thickness of 2 mm was produced by the same method as that in Example 8, except that 0.60 parts by weight (0.60% by weight relative to the total weight of the polymerizable composition part) of u3 (see Comparative Example 1) was used instead of u1 in Example 8.

### Characteristics and the Like of Examples 8 and 9 and Comparative Example 2

Characteristics of a resin composition and a resin cured product (plano lens) of each of Examples 8 and 9 and Comparative Example 2 are shown in [Table 2] below.

TABLE 2

| | Resin composition | | | | | | |
|---|---|---|---|---|---|---|---|
| | | | | Addition amount of | | | |
| | | Resin | | ultraviolet absorber | | | |
| | | monomer | | relative to 100 parts | | | |
| | | ratio | | by weight of resin | Resin cured product | | |
| | Resin | (weight | Ultraviolet | monomer | HEV cut | YI | Resin |
| | monomer | ratio) | absorber | (parts by weight) | rate (%) | value | appearance |
| Example 8 | a1, b2 | 52.0:48.0 | u1 | 0.15 | 62.03 | 3.3 | No abnormality |
| Example 9 | a1, b2 | 52.0:48.0 | u1 | 1.10 | 94.15 | 8.5 | No abnormality |
| Comparative | a1, b2 | 52.0:48.0 | u3 | 0.60 | 42.80 | 2.1 | No abnormality |
| Example 2 | | | | | | | |

HEV cut rate (%):
100-(average of transmittance from 420 nm to 400 nm)
a1: m-xylene diisocyanate
b2: 1,2-bis(2-mercaptoethylthio)-3-mercaptopropane
u1: methyl = 3-[3-t-butyl-5-(5-chloro-2H-benzotriazol-2-yl)-4-hydroxyphenyl]propionate
u3: 2-(4-butoxy-2-hydroxyphenyl)-2H-benzotriazole

First, with respect to the appearance of the plano lens, in Examples 8 and 9 and Comparative Example 2, abnormality such as precipitation of the ultraviolet absorber u1, u3 was not observed.

Next, with respect to the HEV cut rate, even in a case where the polythiol in the resin monomer is b2 (1,2-bis(2-mercaptoethylthio)-3-mercaptopropane), when the ultraviolet absorber is u1 (Examples 8 and 9), the HEV cut rates are significantly increased, i.e., 62.03 and 94.15% (the addition amounts of u1 are 0.15 and 1.10 parts by weight), relative to 42.80% (Comparative Example 2, the addition amount of u3 is 0.60 parts by weight), as shown in the HEV cut rate column in [Table 2].

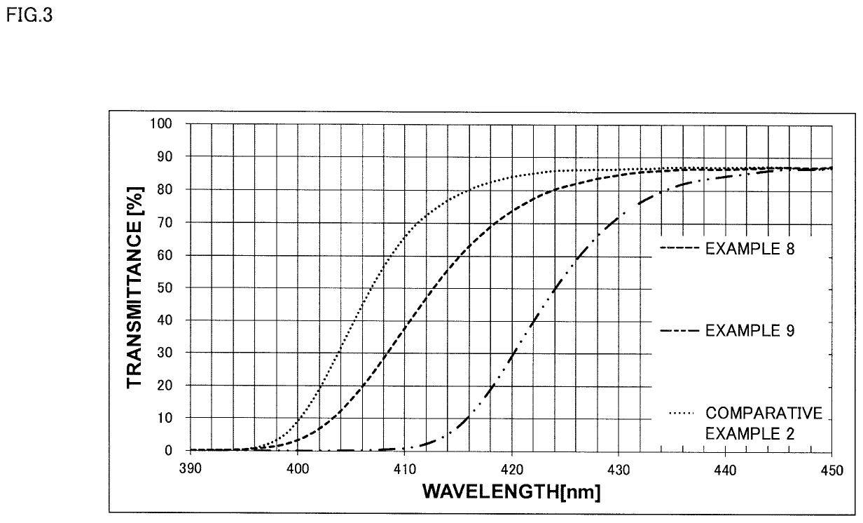

That is, as shown in FIG. 3, in Example 9, when compared with Comparative Example 2 in which the ultraviolet absorber is u3, the rising point of the transmittance distribution curve is shifted to the long wavelength side (420 nm side), i.e., from 396 nm (Comparative Example 2) to about 406 nm (Example 9). It should be noted that the rising point in Example 8 is the same as that in Comparative Example 2. The point at which the transmittance of Examples 8 and 9 becomes 80% is shifted to the long wavelength side, i.e., from 416 nm (Comparative Example 2) to about 424 and 434 nm (Examples 8 and 9, respectively). According to these, the HEV cut rates of Examples 8 and 9 are significantly increased, relative to that in Comparative Example 2.

In particular, in Example 9, the HEV cut rate is not less than 94%, which is very high, and thus, Example 9 has excellent eye protection ability.

It should be noted that in each of Examples 8 and 9 and Comparative Example 2, the transmittance (about 88%) at a wavelength of 450 nm is maintained up to a wavelength of at least 800 nm.

The YI values of Examples 8 and 9 are 3.3 and 8.5, respectively, whereas the YI value of Comparative Example 2 is 2.1.

### Summary and the Like of Examples 8 and 9 and Comparative Example 2

As shown in each of Examples 8 and 9 described above, when a plastic lens includes a plastic lens base material obtained as a result of curing of a polymerizable compound having mixed therein a benzotriazole compound represented by general formula (1) above, and the polymerizable compound contains a combination of a xylene diisocyanate (m-xylene diisocyanate) and a polythiol (1,2-bis(2-mercaptoethylthio)-3-mercaptopropane), the plastic lens and spectacles using the plastic lens have a high HEV cut rate and excellent eye protection ability.

In particular, in Example 9 described above, the HEV cut rate is not less than 94%, which is very high.

In addition, in Examples 8 and 9 described above, the ultraviolet absorber (formula (1-1) above) in which R in general formula (1) is represented by an alkyl group having 1 carbon atom is at a proportion of less than 1.50 parts by weight relative to 100 parts by weight of the polymerizable compound. Accordingly, precipitation of the ultraviolet absorber is prevented, and the appearances of the plastic lens and spectacles using the plastic lens become preferable.

1. A plastic lens comprising
a plastic lens base material obtained as a result of curing of a polymerizable compound having mixed therein a benzotriazole compound represented by general formula (1) below 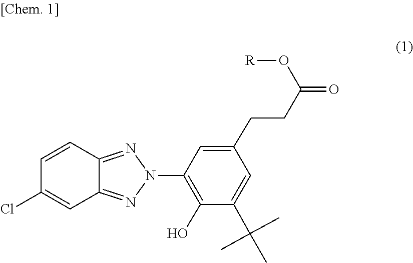
(in general formula (1), R represents an alkyl group having not less than 1 and not more than 8 carbon atoms).

2. The plastic lens according to claim 1, wherein
the polymerizable compound contains a combination of a xylene diisocyanate and a polythiol.

3. The plastic lens according to claim 2, wherein
the xylene diisocyanate is m-xylene diisocyanate.

4. The plastic lens according to claim 2, wherein
the polythiol is at least one of bis(mercaptomethyl)-3,6,9-trithio-1,11-undecanedithiol and 1,2-bis(2-mercaptoethylthio)-3-mercaptopropane.

5. The plastic lens according to claim 1, wherein
an HEV cut rate represented as 100-(average transmittance in a wavelength range of not less than 400 nm and not greater than 420 nm) is not less than 94%.

6. The plastic lens according to claim 4, wherein
the benzotriazole compound is a benzotriazole compound in which R in the general formula (1) is represented by an alkyl group having 1 carbon atom, and is at a proportion of less than 1.50 parts by weight relative to 100 parts by weight of the polymerizable compound.

7. The plastic lens according to claim 4, wherein
the benzotriazole compound is a benzotriazole compound in which R in the general formula (1) is represented by an alkyl group having 8 carbon atoms, and is at a proportion of less than 0.62 parts by weight relative to 100 parts by weight of the polymerizable compound.

8. Spectacles in which the plastic lens according to claim 1 is used.
